(19) United States
(12) Patent Application Publication
(10) Pub. No.: US 2014/0115457 A1
(43) Pub. Date: Apr. 24, 2014

(54) ELECTRONIC DEVICE AND METHOD FOR READING HELP FILES OF SOFTWARE PROGRAM

(71) Applicant: HON HAI PRECISION INDUSTRY CO., LTD., New Taipei (TW)

(72) Inventor: Chen-Wei HSU, New Taipei (TW)

(73) Assignee: HON HAI PRECISION INDUSTRY CO., LTD., New Taipei (TW)

(21) Appl. No.: 13/971,989

(22) Filed: Aug. 21, 2013

(30) Foreign Application Priority Data
Oct. 24, 2012 (TW) 101139199

(51) Int. Cl. G06F 3/0484

(52) U.S. Cl. CPC G06F 3/0484
USPC 715/708

(57) ABSTRACT

In a method for reading a help file of a software program, relationships between graphical interfaces of the software program and help items in the help file are generated, and one or more help items related to a currently displayed graphical interface of the software program are loaded according to the relationships. The related help items are classified to generate a help list which includes one or more information items, and the help list is displayed to a user for selecting an information item when the help file is invoked. The related help items are then displayed on a display device according to the selected information item.

### BACKGROUND

1. Technical Field

Embodiments of the present disclosure relate to information management, and more specifically relates to an electronic device and a method for reading help files of a software program.

2. Description of Related Art

A help file is a documentation component of a software program that explains features of the software program and helps a user understand capabilities of the features.

The help file's purpose is to provide answers that a user needs to understand to use the software program effectively.

However, for most help files, it is difficult for the user to check corresponding explanation of particular features of the software program rapidly.

### BRIEF DESCRIPTION OF THE DRAWINGS

FIG. 1 is a block diagram of one embodiment of an electronic device including a help file reading system.

FIG. 2 is a block diagram of one embodiment of function modules of the help file reading system in FIG. 1.

FIG. 3 illustrates a flowchart of one embodiment of a method of reading a help file of a software program.

FIG. 4 is an example illustrating an software program and a help file of the software program.

### DETAILED DESCRIPTION

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device.

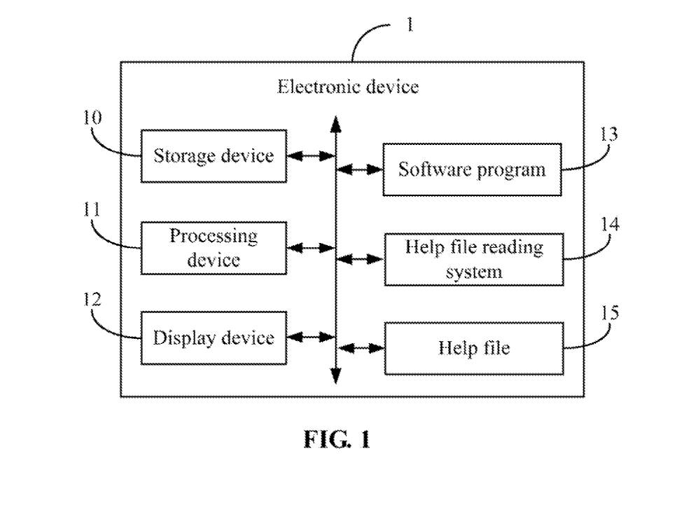

FIG. 1 is a block diagram of one embodiment of an electronic device 1 including a help file reading system 14. The electronic device 1 may be, for example, a computer, a smart phone, or a personal digital assistant (PDA). The electronic device 1 further includes a storage device 10, a processing device 11, and a display device 12. Furthermore, in the electronic device 1, at least one software program is installed. The software program may be an office software suite (such as a word processing software), a browser software (such as FIREFOX), a management software (such as an enterprise resource planning (ERP) system), for example, The software program includes a help file 15 which includes a plurality of help items which explain features of the software program. The help items of the help file 15 can be displayed on the display device 12 when the software program 13 is running.

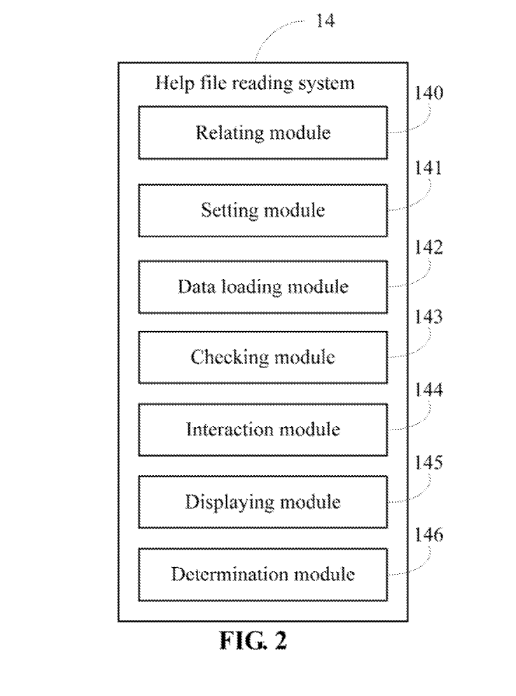

The help file reading system 14 includes a plurality of function modules (see FIG. 2 and below), which include computerized program codes stored in the storage device 10, when executed by the processing device 11, to provide a method of reading the help file 15, enabling a user of the software program 13 to check corresponding help items which explain particular features of the software program 13 in the help file 15 rapidly.

The storage device 10 may include any type(s) of non-transitory computer-readable storage medium, such as a hard disk drive, a compact disc, a digital video disc, or a tape drive. The storage device 11 stores the help file reading system 14 as mentioned above, and further data needed by the help file reading system 14, the software program 13, and the help file 15.

The processing device 11 may be a processor, a microprocessor, an application-specific integrated circuit (ASIC), and a field programmable gate array (FPGA), for example.

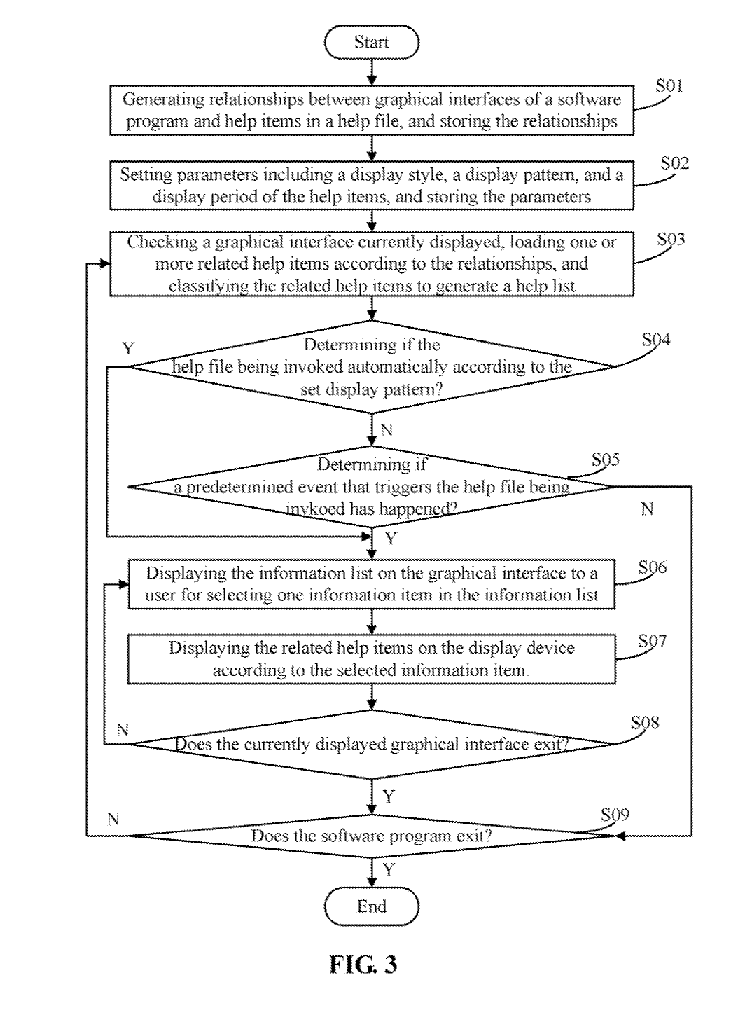

FIG. 2 is a block diagram of one embodiment of the function modules of the help file reading system 14. In one embodiment, the function modules may include a relating module 140, a setting module 141, a data loading module 142, a checking module 143, an interaction module 144, a displaying module 145, and a determination module 146. The functions of the function modules 140-146 are illustrated in FIG. 3 and described below.

FIG. 3 illustrates a flowchart of one embodiment of a method of reading a help file of a software program. Depending on the embodiment, additional steps in FIG. 3 may be added, others removed, and the ordering of the steps may be changed.

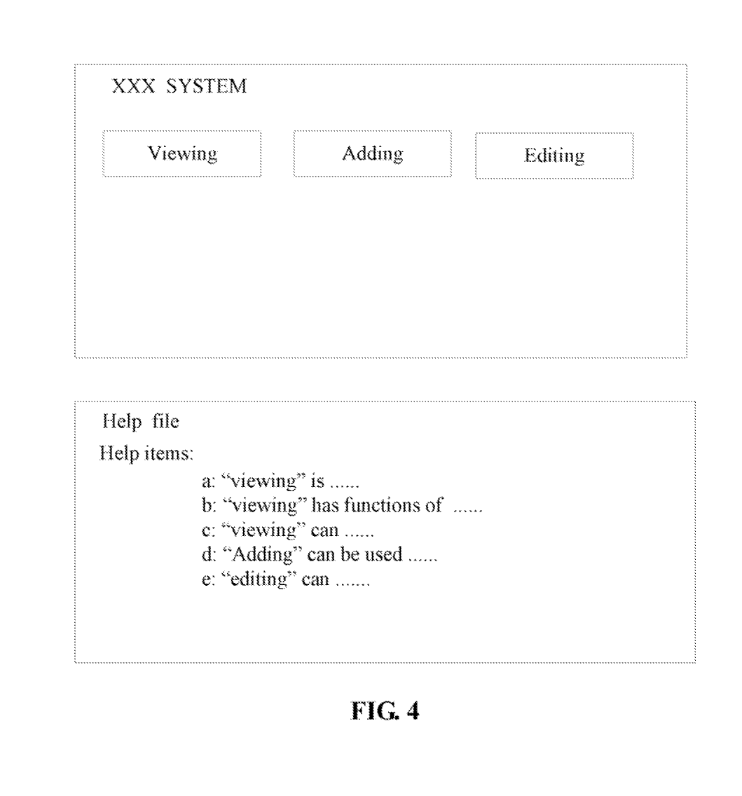

In step S01, the relating module 140 generates relationships between graphical interfaces of the software program 13 and the help items in the help file 15, and stores the relationships into the storage device 10. One graphical interface of the software program 13 can be related to one or more of the help items in the help file 15. For example, referring to FIG. 4, when a feature A “viewing” of a XXX system (namely the software program 13) appears on the graphical interface 1 of the XXX system, and the help items a to c, in the help file of the XXX system, include contents explaining the feature A, then the relating module 140 may generate a relationship which is recorded, for example, using a array, such as {feature A, 1, (a, b, c)}. When a feature B “Adding” of the XXX system appears on the graphical interfaces 1 and 4 of the XXX system, and the help item d, in the help file of the XXX system, includes contents explaining the feature B, then the relating module 140 records {feature B, (1 ,4), d}.

In step S02, the setting module 141 sets display parameters of the help file 15, and stores the display parameters into the storage device 10. The display parameters include a display style, a display period, a display pattern. In one embodiment, the display style includes a separate display style and an embedded display style. The separate display style indicates displaying the help items of the help file 15 using a document separate from the graphical interfaces of the software program 13. The embedded display style indicates displaying the help items of the help file 15 on the graphical interfaces of the software program 13, and making the help items point to corresponding features on the graphical interfaces using, an arrow, for example. The display period includes display periods of the help items. The display pattern includes automatically invoking the help file 15 and triggered invoking the help file 15. Automatically invoking the help file 15 indicates that invoking help items relating to features appearing on a current graphical interface of the software program 13 automatically. For example, referring to FIG. 4, when the graphical interface including features of “viewing” “adding” and “editing” of the XXX system is displayed, the help file 15 is invoked automatically to output the help items a to e. Triggered invoking means the help file 15 is invoked until a predetermined event happened. The predetermined event may be, for example, a predetermined key (physical or virtual) is pressed.

In step S03, the data loading module 142 checks a graphical interface of the software program 13 which is currently displayed on the display device 12, loads one or more related help items according to the relationships stored in the storage device 10. It may be understood that, the graphical interface may includes a plurality of features of the software program 13, the data loading module 142 loads the help items related to all the features on the currently displayed graphical interface according to the relationships. In addition, the data loading module 142 further classifies the related help items according to the contents of the related help items to generate a help list which includes a plurality of information items. For example, the related help items include contents such as a basic function description of each of the features on the currently displayed graphical interface, an operation descriptions of each of the features on the currently displayed graphical interface, for example. Thus, the help list may includes information items, such as a function description of the feature A, a function description of the feature B, an operation description of the feature A, an operation description of the feature B, for example.

In step S04, the checking module 143 determines if the help file 15 is invoked automatically according to the set display pattern. Step S05 is implemented when the help file 15 is not invoked automatically. Otherwise, step S06 is implemented when the help file 15 is invoked automatically.

In step S05, the checking module 143 further determines if a predetermined event that triggers the help file 15 being invoked has happened. The predetermined event may be, for example, a key (physical or virtual) has been pressed. Step S06 is implemented when the predetermined event has happened. Otherwise, step S09 is implemented when no predetermined event has happened.

In step S06, the interaction module 144 displays the help list on the graphical interface to the user for selecting an information item in the help list.

In step S07, the displaying module 145 displays the related help items on the display device 12 according to the selected information item, the set display style and the display period. In one embodiment, a control panel, which includes options of “pause,” “playing,” “previous,” and “next”, can be used to pause display, resume play, play previous, and play next of the help items.

In step S08, the determination module 146 determines if the currently displayed graphical interface exits. Step S06 is implemented when the currently displayed graphical interface does not exit. Otherwise, step S09 is implemented when the currently displayed graphical interface exits.

In step S09, the determination module 146 further determines if the software program 13 exits. Step S03 is implemented when the software program 13 does not exit. Otherwise, the procedure ends when the software program 13 exits.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A method for reading a help file of a software program, the help file comprising a plurality of help items which explain features of the software program, the method being executed by at least one processor of an electronic device, and comprising:
generating relationships between graphical interfaces of the software program and the help items in the help file, and storing the relationships into a storage device of the electronic device;
checking a graphical interface of the software program which is currently displayed on a display device of the electronic device, and loading one or more related help items according to the relationships stored in the storage device;
classifying the related help items to generate a help list which includes a plurality of information items;
displaying the help list on the graphical interface to the user for selecting an information item in the help list when the help file is invoked; and
displaying the related help items on the display device according to the selected information item.

2. The method according to claim 1, further comprising:
setting display parameters of the help items, and storing the display parameters into the storage device, wherein the display parameters comprise a display style, display period, and a display pattern.

3. The method according to claim 2, wherein the display style comprises a separate display style that displays the help items using a document separate from the graphical interfaces of the software program, and an embedded display style that displays the help items on the graphical interfaces of the software program.

4. The method according to claim 2, wherein the display pattern comprises automatically invoking the help file and triggered invoking the help file.

5. The method according to claim 4, before displaying the help list, the method further comprising:
determining whether the help file is invoked automatically according to the set display pattern; and
determining whether a predetermined event that triggers the help file being invoked has happened when the help file is not invoked automatically.

6. The method according to claim 1, during displaying the related help items, the method further comprising:
displaying a control panel, which includes options of “pause,” “playing,” “previous,” and “next” to pause display, resume play, play previous, and play next of the help items.

7. An electronic device, comprising:
a processing device;
a storage device storing one or more programs which when executed by the processing device, causes the processing device to:
generate relationships between graphical interfaces of the software program and the help items in the help file, and store the relationships into the storage device;
check a graphical interface of the software program which is currently displayed on a display device of the electronic device, and load one or more related help items according to the relationships stored in the storage device;
classify the related help items to generate a help list which includes a plurality of information items;
display the help list on the graphical interface to the user for selecting an information item in the help list when the help file is invoked; and
display the related help items on the display device according to the selected information item.

8. The electronic device according to claim 7, wherein the processing device further:
set display parameters of the help items, and store the display parameters into the storage device, wherein the display parameters comprise a display style, display period, and a display pattern.

9. The electronic device according to claim 8, wherein the display style comprises a separate display style that displays the help items using a document separate from the graphical interfaces of the software program, and an embedded display style that displays the help items on the graphical interfaces of the software program.

10. The electronic device according to claim 8, wherein the display pattern comprises automatically invoking the help file and triggered invoking the help file.

11. The electronic device according to claim 10, wherein the processing device further:
determine whether the help file is invoked automatically according to the set display pattern; and
determine whether a predetermined event that triggers the help file being invoked has happened when the help file is not invoked automatically.

12. The electronic device according to claim 7, wherein the processing device further:
display a control panel, which includes options of “pause,” “playing,” “previous,” and “next” to pause display, resume play, play previous, and play next of the help items.

13. A non-transitory storage medium having stored thereon instructions that, when executed by a processor of an electronic device, causes the processor to perform method for reading a help file of a software program, the help file comprising a plurality of help items which explain features of the software program, the method comprising:
generating relationships between graphical interfaces of the software program and the help items in the help file, and storing the relationships into a storage device of the electronic device;
checking a graphical interface of the software program which is currently displayed on a display device of the electronic device, and loading one or more related help items according to the relationships stored in the storage device;
classifying the related help items to generate a help list which includes a plurality of information items; and
displaying the help list the graphical interface to the user for selecting an information item in the help list when the help file is invoked; and
displaying the related help items on the display device according to a selected information item.

14. The storage medium according to claim 13, wherein the method further comprises:
setting display parameters of the help items, and storing the display parameters into the storage device, wherein the display parameters comprise a display style, display period, and a display pattern.

15. The storage medium according to claim 14, wherein the display style comprises a separate display style that displays the help items using a document separate from the graphical interfaces of the software program, and an embedded display style that displays the help items on the graphical interfaces of the software program.

16. The storage medium according to claim 14, wherein the display pattern comprises automatically invoking the help file and triggered invoking the help file.

17. The storage medium according to claim 16, wherein before displaying the help list, the method further comprises:
determining whether the help file is invoked automatically according to the set display pattern; and
determining whether a predetermined event that triggers the help file being invoked has happened when the help file is not invoked automatically.

18. The storage medium according to claim 13, wherein during displaying the related help items, the method further comprises:
displaying a control panel, which includes options of “pause,” “playing,” “previous,” and “next” to pause display, resume play, play previous, and play next of the help items.
